(19) United States
(12) Patent Application Publication
(10) Pub. No.: US 2018/0171185 A1
(43) Pub. Date: Jun. 21, 2018

(54) Adhesive Composition And Use Thereof In Electronics

(71) Applicant: Commissariat a l'Energie Atomique et aux Energies Alternatives, Paris (FR)

(72) Inventors: Maryline Roumanie, Coublevie (FR); Cecile Flassayer, Varces-Allieres-et-Risset (FR); Richard Laucournet, La Buisse (FR)

(21) Appl. No.: 15/844,053

(22) Filed: Dec. 15, 2017

(30) Foreign Application Priority Data
Dec. 20, 2016 (FR) 1662808

(51) Int. Cl. C09J 11/04; C09J 183/04

(52) U.S. Cl. CPC C09J 11/04; C08K 3/28; C09J 183/04

(57) ABSTRACT

An adhesive composition includes a polymer, inorganic fillers, and at least one organic solvent. The polymer is at least one preceramic polymer, advantageously based on silicon. The fillers include one or a plurality of thermally conductive and electrically insulating inorganic fillers.

### FIELD OF THE INVENTION

The present invention relates to a thermally conductive and electronically insulating composition.

The field of use of the present invention particularly relates to microelectronics, and more particularly to layer transfer methods.

### BACKGROUND

Due the methods implemented, the manufacturing of microelectronic devices may require an adhesive which can be used over a wide temperature range. Further, it is preferable for this type of adhesive to have specific properties in terms of heat conduction and/or of electric insulation.

More particularly, the manufacturing of a microelectronic device may comprise manufacturing one or a plurality of layers (14) on an initial substrate (11), and then transferring them onto a final substrate (12) possibly supported by a substrate holder (15), and this, by means of an adhesive (13) (FIG. 1).

It is thus possible to form a complex architecture on a substrate capable of resisting the manufacturing conditions before transferring this architecture onto a more fragile substrate.

The presence of an adhesive may turn out to be necessary to ensure the transfer between the initial substrate and the final substrate.

Generally, the polymer adhesives used are acrylics, urethanes, silicones, polyimides, or epoxies since they have the required thermal and/or electric properties.

As an example, documents US 2013/0221479 and US 2012/0086100 describe the use of a thermoplastic adhesive based on acrylic or polyimide to bond a sapphire-type substrate to an electronic device.

Composite adhesives have also been developed. For example, document US 2014/0252566 describes a mixture containing a polymer adhesive and fillers as well as the use thereof in the manufacturing of a semiconductor. The adhesive may be of polyamide, ABS (acrylonitrile butadiene styrene), PEEK (polyetheretherketone), polysulfone type, or an epoxy resin.

Another type of composite adhesive has been described by Xu et al. (Composites: Part A applied science and manufacturing, 2001, 32(12), pages 1749-1757). This adhesive comprises aluminum nitride fillers in an epoxy or poly(vinylidene fluoride) matrix.

Even though existing adhesives may prove to be satisfactory, their operating temperature is not optimal. Further, some of them appear in the form of pellets, making their use tedious in microelectronics.

Indeed, the temperatures used to manufacture microelectronic devices may turn out to be incompatible with certain adhesives due to their degradation or to their decomposition at high temperature, which limits their use. The operating temperature of conventionally-used adhesives is the following:
acrylics: from −65 to 125° C.,
urethanes: from −40 to 125° C.,
silicones: from −50 to 300° C.,
polyimides: from −140 to 225° C. (from −260 to 400° C. for Kapton®),
epoxies: from −55 to 200° C.

In addition to the resistance to temperatures compatible with the manufacturing of a microelectronic device, these adhesives should also have a satisfactory thermal conductivity.

The Applicant has developed an adhesive composition having the adequate properties for a use in microelectronics, be it in terms of stability over a wide temperature range, of heat conduction, or of electric insulation.

### SUMMARY OF THE INVENTION

The present invention relates to an adhesive composition having properties which enable to use it in microelectronic device manufacturing.

It is a thermally conductive, electrically insulating adhesive solution, crosslinkable at low temperature and capable of being used at a temperature of 350° C. or more, while conventional glues degrade or decompose at such temperatures. Further, it has a thermal conductivity advantageously of at least 2 W/m·K.

More specifically, the present invention relates to an adhesive composition comprising:
at least one preceramic polymer, advantageously based on silicon,
one or a plurality of thermally conductive and electrically insulating inorganic fillers,
at least one organic solvent.

The preceramic polymer has a temperature withstand advantageously greater than 350° C., which enables to transform it at high temperature into a ceramic. Thus, advantageously, the adhesive composition according to the invention has a thermal stability beyond 250° C.

The temperature withstand of silicones being much smaller than 350° C., silicone-polyimide-type resins correspond neither to the adhesive composition according to the invention, nor to preceramic polymers.

Advantageously, the adhesive composition has a low thermal expansion coefficient at the operating temperature, advantageously less than 20 ppm/° C. at 250° C., more advantageously in the order of 10 ppm/° C. at 250° C. Further, and also advantageously, the thermal expansion coefficient no longer varies after a treatment at 250° C., particularly after tens of hours at 250° C., for example, after 168 hours at 250° C. Thus, a thermal stabilization may be obtained beyond 250° C. Conversely, prior art silicones generally degrade at 250° C. or more and have a thermal expansion coefficient which may vary from 30 to 300 ppm/° C.

In practice, this adhesive composition is deposited on a substrate before being dried, and possibly thermally treated. This results in an adhesive layer which thus corresponds to the adhesive layer which has been dried and possibly thermally treated.

According to the invention, the adhesive composition comprises at least one preceramic polymer, advantageously based on silicon. It is a polymer forming a ceramic precursor, for example, SiO₂ in the case of a preceramic polymer based on silicon.

In other words, a preceramic polymer is capable of totally or partly transforming into a ceramic when it is submitted to a thermal treatment. According to the desired ceramic, the thermal treatment may be carried out in air or not.

Advantageously, the preceramic polymer is selected from the group comprising polysiloxanes, polysilsesquioxanes, polycarbosiloxanes, polyborosilanes, polyborosiloxanes, polysilazanes, polysilsesquiazanes, polyborosilazanes, polycarbosilanes, polysilylcarbodiimides, and polysilsesquicarbodiimides.

Preferably, the preceramic polymer is a polysiloxane, advantageously a polysiloxane comprising one or a plurality of repeated siloxane patterns, where the silicon atom is covalently bonded to groups R¹ and R² according to the following formula (I):

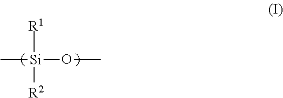

In formula (I), R¹ and R² advantageously correspond, independently from each other, to a hydrogen atom, or an alkyl group, or an aromatic group, provided for at least one of groups R¹ and R² to correspond to an alkyl group.

According to a specific embodiment of the invention, R¹ and R² may both correspond to an alkyl group, advantageously the same alkyl group.

According to another specific embodiment, the preceramic polymer may be a polysiloxane of formula —(SiR¹R²—X)— with X═O, C, B, or N (C, B, and N being generally substituted).

Advantageously, the alkyl group(s) of the siloxane pattern according to formula (I) comprise from 1 to 4 carbon atoms. These are advantageously groups selected from the group comprising methyl, ethyl, propyl, isopropyl, n-butyl, isobutyl, and tert-butyl; the methyl group being particularly preferred. Thus, R¹ and R² advantageously correspond to a methyl group.

Advantageously, the aromatic group(s) of the siloxane pattern according to formula (I) comprise from 6 to 9 carbon atoms. These advantageously are phenyl, benzyl, o-tolyl, m-tolyl, p-tolyl, o-xylyl, and mesityl groups; the phenyl group being particularly preferred.

In addition to the repeated siloxane pattern(s) according to formula (I), the preceramic polymer may comprise other types of repeated siloxane patterns. In this case, the repeated siloxane pattern(s) according to formula (I) advantageously represent more than 50 wt. % of the weight of the preceramic polymer.

The preceramic polymer may also be an organic/inorganic compound containing both the basic structure of the desired ceramic and an organic peripheral environment providing different functionalities.

Further, the preceramic polymer is advantageously crosslinkable.

Generally, a preceramic polymer based on silicon is capable of forming silica SiO₂ when it is submitted to a thermal treatment, possibly in the presence of oxygen.

Thus, the preceramic polymer may comprise a repeated pattern of formula (I), with preferably R¹═R²═CH₃, and may have the ability to form, after ceramization (full oxidation) at least 80 wt. % of silica SiO₂ with respect to the total weight of the solid polymer remaining after the full oxidation.

It may in particular be preceramic polymer Silres® MK commercialized by Wacker. This polymer has a high silica-forming ability (approximately 82 wt. % with respect to the total weight of the solid polymer remaining after the full oxidation).

Further, the preceramic polymer is advantageously soluble in many organic solvents, such as aromatic solvents, ester solvents, or ketone solvents.

Advantageously, the preceramic polymer represents from 15 to 50 wt. % with respect to the total weight of the adhesive composition, more advantageously from 25 to 35 wt. %.

As already indicated, the adhesive composition according to the invention also comprises one or a plurality of types of inorganic fillers.

The inorganic fillers (hereafter, “fillers”) are thermally conductive and electrically insulating.

They may in particular be fillers selected from the group comprising AlN; Al₂O₃; hBN (hexagonal boron nitride); silicon nitride; ceramics based on silicon, aluminum, oxygen and nitrogen, for example, SiAlON; and BeO.

With no connection to any theory, the Applicant considers that the presence of inorganic fillers enables to increase the thickness of the deposited adhesive layer due to an increase in the viscosity of the composition. It further enables to prevent risks of cracking during a possible thermal treatment of the adhesive composition. Finally, the present of fillers enables to obtain a percolating network and thus to control the thermal conductivity, that is, the thermal conduction properties of the adhesive composition.

It is thus possible to modulate the properties of the adhesive composition according to the nature and/or to the quantity of charges. These properties may also be modulated by the presence of fillers having different shapes and/or different sizes and/or by the functionalization of the fillers.

The fillers may in particular have the shape of spheres, of threads, of rods, and of combinations thereof.

The filler size is generally in the range from a few nanometers to several tens of micrometers. It generally depends on the desired adhesive layer thickness (deposited adhesive composition). In other words, the filler size is advantageously proportional to the thickness of the deposited adhesive composition layer. Also, to optimize the density of the adhesive composition, a compact stack of fillers is desirable. For this purpose, it is advantageous to use a mixture of fillers of different sizes, for example, a mixture of 3 filler sizes.

As already indicated, the fillers may be functionalized. This specific embodiment enables to improve the homogeneity of the adhesive composition. More particularly, the functionalization of the fillers enables to improve their wettability in the adhesive composition. A better wettability particularly results in the removal of possible bubbles of gas (for example, air) around the fillers.

The fillers may in particular be functionalized with compounds selected from APTES (3-aminopropyltriethoxysilane), glymo ((3-glycidyloxypropyl) trimethoxysilane), or any type of silanes compatible with the filler and the preceramic polymer.

The filler functionalization with APTES or GLYMO is particularly adapted for a preceramic polymer based on silicon, for example, a polysiloxane.

The fillers advantageously represent from 60 vol. % (volume content) to 80 vol. % with respect to the total volume of the preceramic polymer and of the fillers, more advantageously from 65 to 80 vol. %, and more advantageously still from 65 to 75 vol. %.

A quantity of fillers smaller than 60 vol. % decreases the thermal conductivity of the adhesive composition due to the increase in the quantity of preceramic polymer which is not thermally conductive. However, a quantity of fillers greater than 80 vol. % decreases the adhesive properties of the adhesive composition, the fillers being not integrally coated by the adhesive composition. On the other hand, too high a quantity of fillers with respect to the adhesive composition generates the forming of pores, and thus a decrease in the thermal conductivity due to the presence of bubbles of gas (for example, air) in the adhesive composition.

Advantageously, the fillers represent from 52 to 75 wt. % with respect to the total weight of the adhesive composition, more advantageously from 58 to 75 wt. %.

The weight ratio between the preceramic polymer and the inorganic fillers is advantageously in the range from 1:4 to 1:11, more advantageously from 1:5 to 1:11 by weight.

Finally, the adhesive composition comprises at least one organic solvent. This solvent advantageously is an aprotic polar solvent, for example, an organic solvent selected from the group comprising ketones, esters, ethers, aromatic solvents (such as aromatic hydrocarbons), halogenated solvents (such as chloroform), and mixtures thereof. The solvent may also be an alkane, for example, hexane, particularly when the preceramic polymer is a polysiloxane.

More specifically, the composition may comprise, as an organic solvent:
a solvent of aromatic hydrocarbon type, advantageously xylene, or
a specific ketone solvent, advantageously butan-2-one (also known as methylethylketone); or
a mixture propylene glycol monomethyl ether, of 2-methoxy-1-methylethyl acetate, of alkanes, and of aromatic compounds, for example, a solvent referenced under trade name Diestone®.

The organic solvent advantageously represents from 15 to 35 wt. % with respect to the weight of the adhesive compound, more advantageously from 15 to 30 wt. %.

Advantageously, the adhesive composition also comprises a coupling agent. The coupling agent enables to ease the crosslinking of the preceramic polymer, the bonding between the substrate and the adhesive layer (resulting from the deposition of the adhesive composition), to decrease the viscosity of the suspension, and to improve the quality of the inorganic filler dispersion.

The coupling agent may be selected from the group comprising (3-glycidyloxypropyl) trimethoxysilane (trade name Dynasylan® GLYMO), N-(2-aminoethyl)-3-aminopropyltrimethoxysilane, and 3-methacryloxypropyl trimethoxysilane. These compounds are particularly adapted when the preceramic polymer is a polysiloxane.

The coupling agent, when present, may represent from 0.1 to 2 wt. % with respect to the total weight of the preceramic polymer.

According to the nature of the possible thermal treatment to which it is submitted after having been deposited, the adhesive composition may comprise other additives.

Indeed, when the drying step is followed by a step of crosslinking the preceramic polymer, the adhesive composition advantageously comprises a catalyst for crosslinking the preceramic polymer.

The catalyst enables to lower the crosslinking temperature of the preceramic polymer. It may be selected from metallic salts, for example, platinum, tin, aluminum, or zirconium salts; organotin compounds; peroxide compounds; and amine compounds. These compounds are particularly adapted to crosslink a polysiloxane-type preceramic polymer.

The crosslinking catalyst may in particular be selected from the group comprising triethanolamine, tetrabutylammonium acetate, aluminum acetylacetonate, zirconium acetylacetonate, and platinum acetylacetonate.

The crosslinking catalyst may represent from 0 to 2 wt. % with respect to the weight of preceramic polymer.

As already indicated, during its use, the adhesive composition is generally deposited on a substrate.

Also, the present invention also relates to a method of preparing an adhesive layer by deposition of the adhesive composition on a substrate.

The present invention also relates to the adhesive layer resulting from the deposition of the adhesive composition, the drying thereof, and the possible thermal treatment thereof. The thermal treatment may allow the crosslinking and/or the ceramization of the preceramic polymer. The drying (removal of the organic solvent) may be carried out by thermal treatment also causing the crosslinking and/or the ceramization of the preceramic polymer.

The drying enables to remove the organic solvent while the thermal treatment, advantageously in air, allows the total or partial crosslinking and/or the total or partial ceramization of the preceramic polymer.

Thus, the adhesive layer may be formed by the dried adhesive composition. It may comprise at least one crosslinked and/or ceramized polymer. The crosslinking of the preceramic polymer and the ceramization thereof may be partial or preferably total.

The adhesive layer advantageously comprises:
a ceramized preceramic polymer and thermally conductive and electrically insulating inorganic fillers, or
a crosslinked preceramic polymer and thermally conductive and electrically insulating inorganic fillers.
a crosslinked and ceramized preceramic polymer and thermally conductive and electrically insulating inorganic fillers.

The weight ratio of the polymer ceramic or the crosslinked preceramic polymer to the inorganic fillers is advantageously in the range from 1:4 to 1:11, more advantageously from 1:5 to 1:11 by weight.

The presence of fillers during the crosslinking and/or the ceramization of the preceramic polymer provides a homogeneous adhesive layer where the fillers are distributed within the polymer or the ceramic.

Since the adhesive composition comprises an organic solvent and, thereby, is liquid, it may be deposited by any liquid deposition technique, which deposition technique will be selected according to the desired thickness of the adhesive layer.

Thus, the composition may be deposited by doctor blade spreading. This technique is particularly adapted for a deposition on a planar surface, for example, on a wafer-type semiconductor substrate, and for the obtaining of a deposit having a thickness which may reach 300 am. This technique may also enable to form a self-supporting adhesive composition layer.

The adhesive composition may also be deposited by spray coating. This technique is particularly capable of forming a deposit having a thickness in the range from 15 to 20 μm.

Other embodiments comprise depositing the adhesive composition by printing, particularly by silk screening, or by spin coating.

It will be within the abilities of those skilled in the art to adapt the deposition technique according to the desired thickness, but also according to the geometry of the substrate to be covered.

Prior to the deposition step, the method of the invention may comprise a step of preparing the above-defined composition, the preparation step conventionally comprising placing in contact the different ingredients forming the composition and mixing them to obtain a homogeneous mixture.

After the deposition step, the method of the invention comprises a thermal treatment step comprising drying said composition.

The drying comprises removing the organic solvent(s) by evaporation, thus only leaving a layer made of a composite material comprising a preceramic polymer, one or a plurality of types of inorganic fillers with heat conduction and electric insulation properties and, possibly, at least one additive such as a coupling agent and/or a crosslinking catalyst.

For its implementation, the drying may comprise letting the composition thus deposited dry in free air, or applying a heating at an appropriate temperature and for an appropriate duration to cause the evaporation of the organic solvent(s). The selected treatment depends on the nature of the organic solvent(s) used and on their respective evaporation temperatures.

As already indicated, after the drying step, the method according to the invention may comprise a thermal treatment step comprising crosslinking and/or ceramizing the preceramic polymer.

The crosslinking is materialized by the creation of chemical bridges between the macromolecular chains of the preceramic polymer. This results in an increase of intermolecular bonds, of —Si—X— type in the case of a preceramic polymer based on silicon (X═Si, O, C, N, or B) within the adhesive layer, and thus by a hardening thereof. Further, the crosslinking enables to increase the cohesion and the mechanical resistance of the adhesive layer. It also enables to improve its adherence to the substrate, which may in particular be made of silicon. It is thus possible to use the adhesive composition in layer transfer methods currently implemented in microelectronics. This also enables to improve the thermal conductivity of the system.

The adhesive composition is preferably crosslinked at a temperature lower than or equal to 200° C. As already indicated, the presence of a crosslinking catalyst enables to lower this temperature.

Generally, the crosslinking may be performed in a furnace so that the heat distribution is uniform.

It may also be performed by means of a heat press to perform a high-temperature compression to improve the cohesion of the adhesive layer and thus increase the thermal conductivity. The use of a heat press also enables to improve the surface condition of the adhesive composition by decreasing its roughness.

According to a specific embodiment, the method may be completed by a step of ceramizing the preceramic polymer, for example, made of SiO₂ when the preceramic polymer is based on silicon. The ceramization step is advantageously carried out after or simultaneously to a crosslinking step. This specificity of the preceramic polymer enables to include all thermal budgets resulting from microelectronics processes.

The present invention also relates to an adhesive layer prepared from the above-described adhesive composition; an adhesive support formed of a substrate and of this adhesive layer; and the use of this adhesive layer and of this adhesive support in microelectronics, particularly in a layer transfer method.

The substrate having the adhesive composition deposited thereon may for example be made of silicon or of silica.

As already indicated, it will be within the abilities of those skilled in the art to adapt the deposition technique according to the desired thickness, but also according to the geometry of the substrate to be covered.

It will further be within the abilities of those skilled in the art to adjust the quantity of solvent to ease the shaping of the adhesive composition according to the invention.

The invention and the resulting advantages will better appear from the following non-limiting drawings and examples, provided as an illustration of the invention.

### DESCRIPTION OF THE DRAWINGS

FIG. 1 illustrates two conventional methods of layer transfer between two substrates.

FIG. 2 illustrates an adhesive support obtained after the deposition of the adhesive composition according to the invention on a silicon or silica substrate.

FIG. 3 illustrates an adhesive support obtained after the deposition of the adhesive composition according to the invention.

FIG. 4 shows photographs of layers obtained after the deposition of the adhesive composition according to the invention on a silicon or silica substrate after a crosslinking at 200° C.

FIG. 5 shows photographs of layers obtained after the deposition of the adhesive composition according to the invention on a silicon or silica substrate after a thermal treatment at 350° C. for 30 minutes.

FIG. 6 illustrates the thermal conductivity according to the quantity of fillers for adhesive compositions according to the invention.

FIG. 7 corresponds to the enlargement of a portion of FIG. 6.

### DETAILED DESCRIPTION OF THE INVENTION

### Preparation of Samples

A plurality of examples of adhesive compositions according to the invention have been prepared. To achieve this, the following components are mixed before the application of the adhesive composition onto a substrate:
from 15 to 30 vol. % of a polysiloxane having a high rate of conversion into silica (Wacker's reference Silres®MK);
from 60 to 85 vol. % of one or a plurality of inorganic fillers;
a xylene-type solvent.

The volume contents are expressed with respect to the total volume of the adhesive composition except for the organic solvent.

The inorganic fillers used are thermally conductive and electrically insulating fillers with different grain sizes.

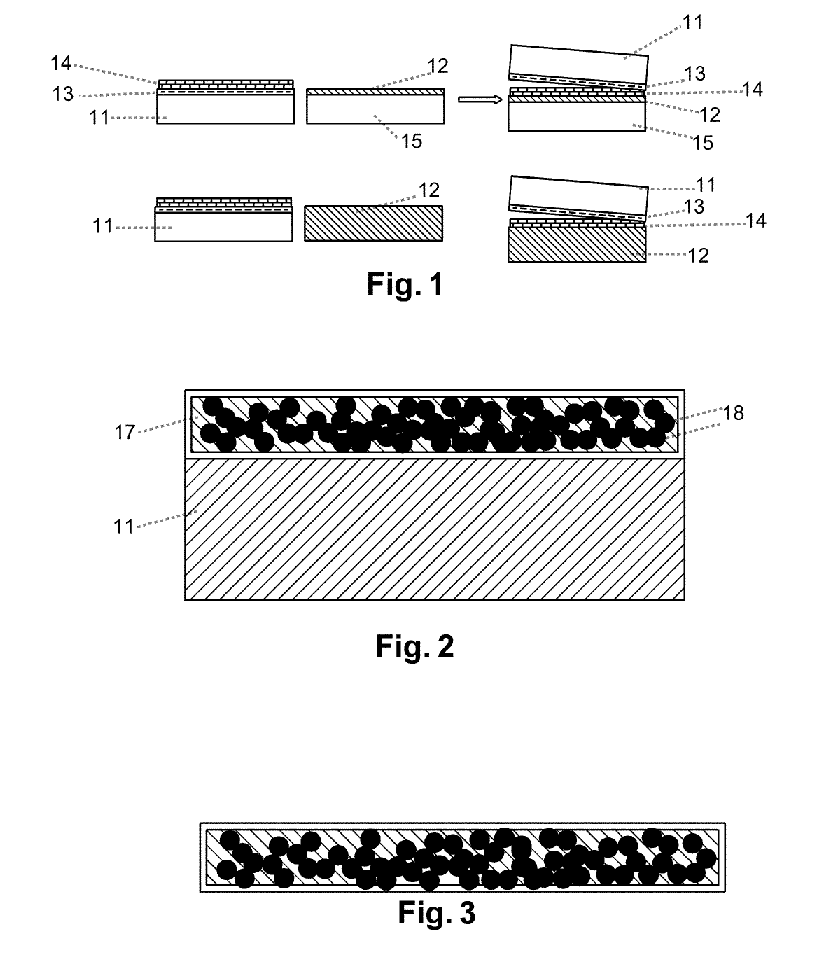

The adhesive composition is homogenized to distribute the inorganic fillers (18) within the preceramic polymer (17) (FIGS. 2 and 3). It is then deposited by spreading with a doctor blade on a silicon or silica substrate (11) (FIG. 2). It may also be used alone, that is, without a substrate (FIG. 3).

The substrate-free deposition enables to form samples to measure the thermal conductivity. It also enables to form a substrate made of adhesive composition, with no support.

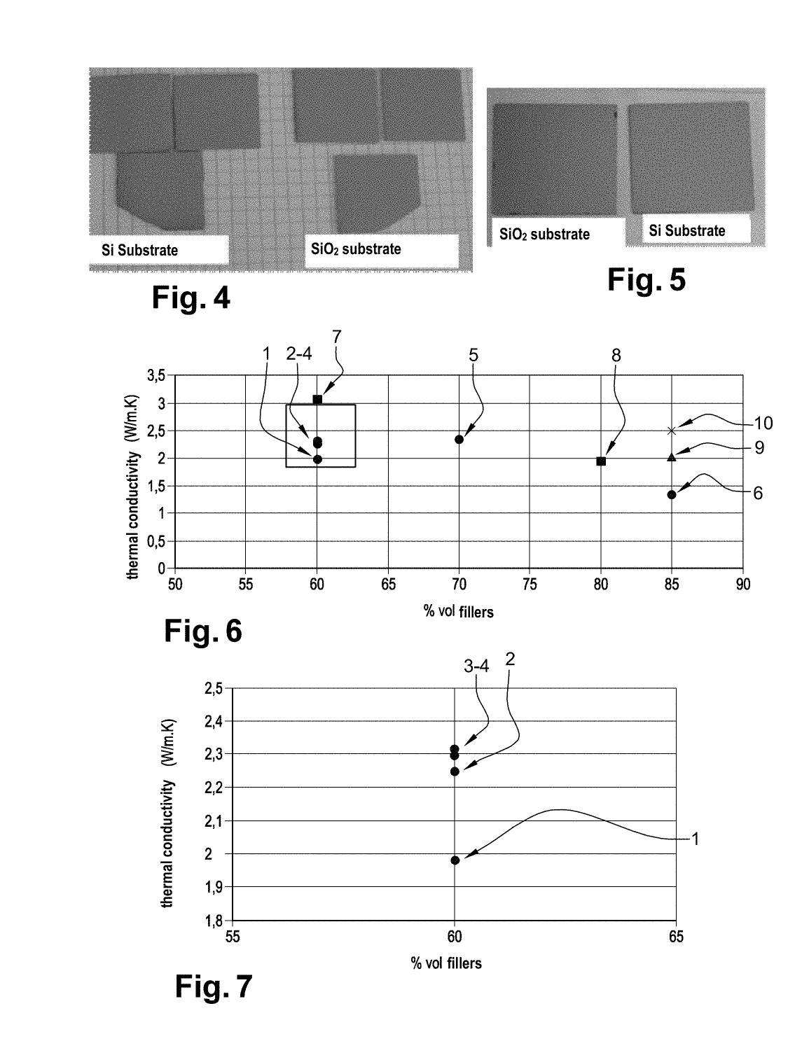

An adhesive layer is obtained after evaporation of the solvent. It is crosslinked, for example, by thermal treatment at 200° C. for 30 minutes (FIG. 4).

TABLE 1
examples of embodiment of the adhesive composition according to the
invention.

| | Example | | | | | | | | | |
|---|---|---|---|---|---|---|---|---|---|---|
| | 1 | 2 | 3 | 4 | 5 | 6 | 7 | 8 | 9 | 10 |
| Fillers | C1 | C1 | C2 | C2 | C1 | C1 | C3 | C3 | C4 | C5 |
| (vol. %) | (60) | (60) | (60) | (60) | (70) | (85) | (60) | (80) | (85) | (85) |
| Polymer | P1 | P1 | P1 | P1 | P1 | P1 | P1 | P1 | P1 | P1 |
| (vol. %) | (40) | (40) | (40) | (40) | (30) | (15) | (40) | (20) | (15) | (15) |

C1: AlN fillers (d50 = 0.125 μm)
C2: functionalized AlN fillers (d50 = 0.125 μm)
C3: AlN fillers (1/d50 = 0.7-11 μm; 2/d50 = 2-4.5 μm: 3/d50 = 0.8-2 μm)
C4: mixture of AlN fillers (d50 = 7.5 μm) and of nanometer AlN fillers
C5: mixtures of fillers C1 + C4
P1: Wacker's Silres ®MK polysiloxane

The volume contents are expressed with respect to the total volume of the adhesive composition, except for the organic solvent.

The adhesive composition according to example 2 has been submitted to a thermal treatment at 350° C. for 30 minutes.

FIGS. 6 and 7 illustrate the thermal conductivity of these adhesive compositions.

### Thermal Tests

The layers obtained by deposition of the adhesive compositions according to examples 1 to 10 have been tested after a thermal treatment at 350° C. for 30 minutes in a furnace under air (FIG. 5). At the end of the thermal treatment, no crack is observed on the layers.

Tests have also been carried out at 450° C., after a crosslinking at 200° C. In this case, the depositions also appear with no cracks.

Tests have also been carried out at 350° C., after a crosslinking at 150° C. In this case, the depositions also appear with no cracks.

No degradation can be observed at the end of these different thermal treatments.

Further, the bonding strength on a silicon substrate has been measured after the thermal treatments. It is approximately in the range from 7 to 8 MPa, which is equivalent or even greater than for conventional epoxy glues.

### Thermal Conductivity

FIGS. 6 and 7 show that the thermal conductivity of the layers obtained by deposition of the adhesive compositions of examples 1 to 10 can be controlled according to the following parameters:
the functionalization of the fillers which improves the wettability of the fillers in the adhesive composition,
a thermal treatment of the adhesive composition at a temperature higher than the crosslinking temperature, which enables to densify the network and favors the percolation,
the filler grain size,
the quantity of fillers.

1. An adhesive composition comprising a polymer, inorganic fillers, and at least one organic solvent, wherein:
the polymer is at least one preceramic polymer, and
the fillers comprise one or a plurality of types of thermally conductive and electrically insulating inorganic fillers.

2. The adhesive composition of claim 1, wherein the preceramic polymer comprises at least one of the following: polysiloxanes, polysilsesquioxanes, polycarbosiloxanes, polyborosilanes, polyborosiloxanes, polysilazanes, poly-silsesquiazanes, polyborosilazanes, polycarbosilanes, polysilylcarbodiimides, and polysilsesquicarbodiimides.

3. The adhesive composition of claim 1, wherein the preceramic polymer represents from 15 to 50 wt. % with respect to a total weight of the adhesive composition.

4. The adhesive composition of claim 1, wherein the inorganic fillers comprise at least one of the following: AlN; Al₂O₃; hBN; silicon nitride; ceramics based on silicon, aluminum, oxygen, and nitrogen; and BeO.

5. The adhesive composition of claim 1, wherein the adhesive composition comprises inorganic fillers having different sizes, different shapes, or both different sizes and different shapes.

6. The adhesive composition of claim 1, wherein the inorganic fillers represent from 60 to 80 vol. % with respect to a total volume of the adhesive composition.

7. The adhesive composition of claim 1, wherein the adhesive composition has a weight ratio of the polymer to the inorganic fillers in the range from 1:4 to 1:11.

8. An adhesive layer formed of the adhesive composition, dried, of claim 1.

9. The adhesive layer of claim 8, wherein said layer comprises at least one preceramic polymer that is crosslinked, ceramized, or both crosslinked and ceramized.

10. A use of the adhesive layer of claim 8 in microelectronics, in a layer transfer method.

11. The adhesive composition of claim 1, wherein the polymer comprises at least one silicon based preceramic polymer.

12. The adhesive composition of claim 7, wherein the adhesive composition has a weight ratio of the polymer to the inorganic fillers in the range from 1:5 to 1:11.
